(19) United States
(12) Patent Application Publication
(10) Pub. No.: US 2026/0349902 A1
(43) Pub. Date: Nov. 5, 2026

(54) FLOW LINE AGGREGATION DEVICE, METHOD, AND PROGRAM

(71) Applicant: NTT, Inc., Tokyo (JP)

(72) Inventors: Miyuki IMADA, Tokyo (JP); Hisashi KURASAWA, Tokyo (JP); Masakuni ISHII, Tokyo (JP); Yoshifumi FUKUMOTO, Tokyo (JP); Kensuke FUKUSHIMA, Tokyo (JP); Tetsuya SHIODA, Tokyo (JP); Susumu YAMAMOTO, Tokyo (JP)

(73) Assignee: NTT, Inc., Tokyo (JP)

(21) Appl. No.: 19/120,300

(22) PCT Filed: Oct. 12, 2022
(86) PCT No.: PCT/JP2022/038114

§ 371 Date: Apr. 11, 2025

(51) Int. Cl. G06F 11/34; G06N 5/01

(52) U.S. Cl. CPC G06F 11/3438; G06N 5/01

(57) ABSTRACT

An extraction unit (21) extracts a common page transition pattern for each of a completion flow line reaching an action or a state indicating completion and a withdrawal flow line withdrawing without reaching the action or the state indicating the completion from a plurality of pieces of flow line information indicating transition of the action or the state for each user, a conversion unit (22) creates a matrix in which presence or absence of appearance for each pattern is stored from the pattern for each user, performs dimension compression for the matrix, and converts the matrix into latent variables for each user, a creation unit (25) creates a decision tree for classifying the completion flow line and the withdrawal flow line on the basis of the latent variable for each user, and a visualization unit (29) visualizes information related to the classification of the completion flow line and the withdrawal flow line on the basis of the decision tree.

### TECHNICAL FIELD

The disclosed technique relates to a flow line aggregation device, a flow line aggregation method, and a flow line aggregation program.

### BACKGROUND ART

In recent years, combined with the Corona disaster, many companies are switching from a face-to-face contract and support at a store to a response on the Web. Since face-to-face service in service design is mainstream so far, a shift to Web procedure is on the way. Actually, there is a case where customers at a fixed rate withdraw during the Web procedure. Many companies want to grasp which page on the Web has a cause of withdrawal. However, when a Web flow line of the customer is displayed as it is by using a Sankey diagram or the like, it is difficult to determine which page has a problem because the Web flow line is in a spaghetti shape.

When various services and procedures on the Web are provided to the customers, a company operating a site usually performs route design (flow line design) on the Web so as to move on a route optimal to the customer. The flow line design includes page transition design to which page the customer should move from which page, layout design in a customer's perspective in the page, and the like.

There is a technique for reporting a movement route or the like of the customer in the site (for example, NPL 1). In the technique of NPL 1, it is often utilized to find contents used by many users at the site by the report in which the route of the user movement in the page and between events is visualized and expressed.

### CITATION LIST

### Non Patent Literature

[NPL 1] “google analytics action flow”, [online], [retrieved on Aug. 31, 2022], Internet <URL: https://support.google.com/analytics/answer/2785577?hl=ja#zipp y=%2C%E3%81%93%E3%81%AE%E8%A8%98%E4%BA%8B%E3%81%AE%E5%86%85%E5SAE%B9>

### SUMMARY OF INVENTION

### Technical Problem

The Web flow line of the user is different for each user, and as mentioned above, the Web flow lines become the spaghetti shape when these are visualized, and it is difficult to grasp what type of action the user takes. This problem is more remarkable in the case of the Web flow line having high arbitrariness. For example, when a target contract procedure is performed on the Web, it is not necessary to browse all the related pages, and visit order to each page do not necessarily have to be as assumed. Due to such an arbitrariness, a large number of patterns are extracted from the Web flow line, and it becomes difficult to grasp features of the flow line. For example, it is necessary to check the patterns with a high number of visiting pages and frequencies preferentially, to determine whether the extracted patterns are meaningful on a case-by-case basis, and the like.

In order to grasp the features and causes of the flow lines such as what type of user is easy to withdraw, it is necessary to aggregate the flow lines, to improve readability, and to have a means by which a person can easily guess.

Conventionally, the person manually performs pruning on a plurality of flow lines while observing a result of basic statistics. Since this work takes much labor and time, it takes much cost to investigate various Web flow lines.

In addition, there is a possibility to grasp the latent potential problems in the content by formulating some hypotheses and narrowing down the number of users by using the report such as the conventional technique. However, in order to interpret a large number of Web flow lines having high arbitrariness as mentioned above, it is difficult to interpret the results indicated by the report unless some processing is performed on an analysis side.

The disclosed technique has been devised in consideration of the points described above and an object thereof is to aggregate the flow lines so that the person can easily interpret.

### Solution to Problem

A first aspect of the present disclosure is a flow line aggregation device including an extraction unit that extracts a common transition pattern for each of a completion flow line reaching an action or a state indicating completion and a withdrawal flow line withdrawing without reaching the action or the state indicating the completion from a plurality of pieces of flow line information indicating transition of the action or the state for each user, a conversion unit that creates a matrix in which presence or absence of appearance for each pattern is stored from the pattern for each user extracted by the extraction unit, performs dimension compression for the matrix, and converts the matrix into latent variables for the respective users, a creation unit that creates a decision tree for classifying the completion flow line and the withdrawal flow line on the basis of the latent variable for the respective users converted by the conversion unit, and a visualization unit that visualizes information related to the classification of the completion flow line and the withdrawal flow line on the basis of the decision tree created by the creation unit.

A second aspect of the present disclosure is a flow line aggregation method including extracting, by an extraction unit, a common transition pattern for each of a completion flow line reaching an action or a state indicating completion and a withdrawal flow line withdrawing without reaching the action or the state indicating the completion from a plurality of pieces of flow line information indicating transition of the action or the state for each user, creating, by a conversion unit, a matrix in which presence or absence of appearance for each pattern is stored from the pattern for each user extracted by the extraction unit, performing dimension compression for the matrix, and converting the matrix into latent variables for the respective users, creating, by a creation unit, a decision tree for classifying the completion flow line and the withdrawal flow line on the basis of the latent variable for the respective users converted by the conversion unit, and visualizing, by a visualization unit, information related to the classification of the completion flow line and the withdrawal flow line on the basis of the decision tree created by the creation unit.

A third aspect of the present disclosure is a flow line aggregation program causing a computer to function as each unit of a flow line aggregation device described above.

### Advantageous Effects of Invention

According to the disclosed technique, the flow lines can be aggregated so that the person can easily interpret.

### BRIEF DESCRIPTION OF DRAWINGS

FIG. 1 is a block diagram showing a hardware configuration of a flow line aggregation device.

FIG. 2 is a block diagram showing an example of a functional configuration of the flow line aggregation device according to a first embodiment.

FIG. 3 is a diagram for explaining creation and dimension compression of a data matrix.

FIG. 4 is a schematic diagram showing one example of a decision tree.

FIG. 5 is an enlarged diagram of a part of the decision tree.

FIG. 6 is a diagram showing one example of displaying a flow line aggregation screen.

FIG. 7 is a flowchart showing a flow of flow line aggregation processing.

FIG. 8 is a flowchart showing a flow of visualization processing.

FIG. 9 is a block diagram showing an example of a functional configuration of a flow line aggregation device according to a second embodiment.

FIG. 10 is a flowchart showing a flow of decision processing.

### DESCRIPTION OF EMBODIMENTS

Hereinafter, one example of embodiments of the disclosed technique will be described with reference to the drawings. Note that, in each drawing, the same or equivalent constituent components and portions are denoted by the same reference numerals. In addition, dimensional ratios in the drawings are exaggerated for convenience of description and may differ from actual ratios.

### First Embodiment

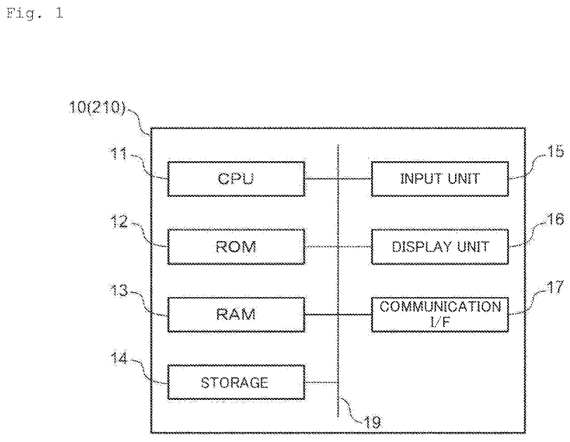

FIG. 1 is a block diagram showing a hardware configuration of a flow line aggregation device. As shown in FIG. 1, the flow line aggregation device 10 has a CPU (Central Processing Unit) 11, a ROM (Read Only Memory) 12, a RAM (Random Access Memory) 13, a storage 14, an input unit 15, a display unit 16, and a communication I/F (Interface) 17. Each constituent component is communicatively connected to each other via a bus 19.

The CPU 11 is a central processing unit and executes various programs or controls each unit. That is, the CPU 11 reads the program from the ROM 12 or the storage 14 and executes the program using the RAM 13 as a work region. The CPU 11 performs control of above-described each configuration component and various types of arithmetic processing in accordance with the programs stored in the ROM 12 or the storage 14. In the present embodiment, a flow line aggregation program for executing the flow line aggregation processing mentioned below is stored in the ROM 12 or the storage 14.

The ROM 12 stores various programs and various types of data. The RAM 13 temporarily stores the program or data as the work region. The storage 14 is constituted by a storage device such as an HDD (Hard Disk Drive) or an SSD (Solid State Drive) and stores various programs including an operating system, and various types of data.

The input unit 15 includes a pointing device such as a mouse and a keyboard, and is used to perform various inputs. The display unit 16 is, for example, a liquid crystal display and displays various types of information. The display unit 16 may adopt a touch panel scheme and function as the input unit 15. The communication I/F 17 is an interface for communication with other equipment. For such communication, for example, a wired communication standard such as Ethernet (registered trademark) or FDDI, or a wireless communication standard such as 4G, 5G, or Wi-Fi (registered trademark) is used.

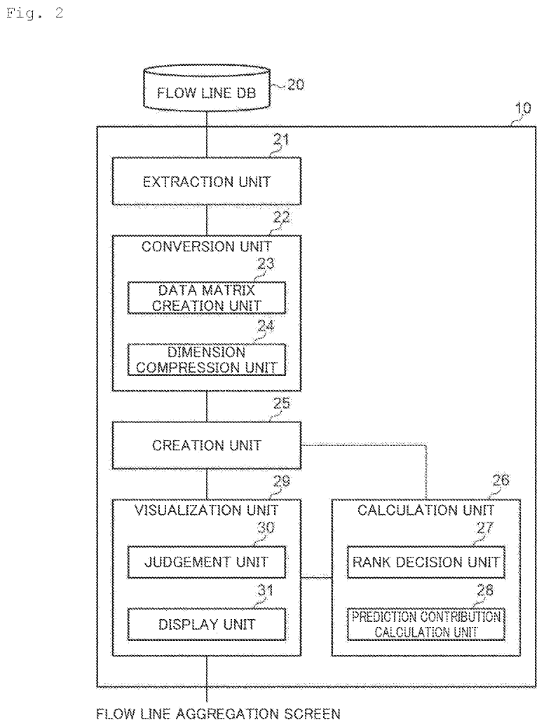

Next, a functional configuration of the flow line aggregation device 10 will be described. FIG. 2 is a block diagram showing an example of the functional configuration of the flow line aggregation device 10. As shown in FIG. 2, the flow line aggregation device 10 has an extraction unit 21, a conversion unit 22, a creation unit 25, a calculation unit 26, and a visualization unit 29 as the functional configuration. The conversion unit 22 further includes a data matrix creation unit 23 and a dimension compression unit 24. The calculation unit 26 further includes a rank decision unit 27 and a prediction contribution calculation unit 28. The visualization unit 29 further includes a judgement unit 30 and a display unit 31. Each functional constituent component is realized by causing the CPU 11 to read the flow line aggregation program stored in the ROM 12 or the storage 14, deploy it into the RAM 13, and execute it.

The extraction unit 21 acquires a plurality of pieces of flow line information stored in a flow line DB (database) 20. The flow line information is information indicating a Web page transition for each user, which is an example of transition of an action or a state for each user, and for example, a pair of identification information (for example, URL) of the Web page to which the user visits and time point information when the Web page is visited is arranged in time series.

The extraction unit 21 extracts a common page transition pattern from the plurality of pieces of acquired flow line information about a completion flow line that is a flow line for the user who has completed the Web procedure as one example of the flow line reaching an action or a state indicating completion. In addition, the extraction unit 21 extracts a common page transition pattern for a withdrawal flow line which is the flow line for the user who has withdrawn the Web procedure as one example of the flow line withdrawing without reaching the action or the state indicating the completion. Note that, in the present embodiment, when the user makes a reservation on the Web to visit the store in order to perform the procedure at the store, the procedure itself of making the reservation is completed, but the flow line is a withdrawal flow line, since the procedure that should be originally performed on the Web (for example, changing a contract and the like) is not completed.

Specifically, the extraction unit 21 divides each of the flow line information for each session which is a large flow line mass in which user action changes. The session is, for example, a session for searching, a session for performing a contract action, a session for confirming points and the like, and the like. For example, a series of actions in which a transition time between Web pages becomes a sufficiently short prescribed time or less is regarded as one session, and when the transition time exceeds the prescribed time, it is regarded as being switched to another session. Then, the extraction unit 21 calculates the transition time between Web pages on the basis of time point information of visiting each Web page included in the flow line information, and separates the flow line information between Web pages whose transition time exceeds the prescribed time to divide the flow line information for each session.

In addition, the present invention uses a method which finds patterns, in the session, that indicate a transition set of Web pages that represent the flow line commonly traced by users who have completed the Web procedures. As a rough image, the session is a transition set of ten to several tens of Web pages, and the pattern is a transition set of several Web pages included in each session.

The extraction unit 21 extracts the pattern from the session obtained by dividing each of the completion flow line and the withdrawal flow line for each user by using an extraction algorithm of frequent pattern mining such as PrefixSpan, for example. In the following description, when a session obtained by dividing the completion flow line and a session obtained by dividing the withdrawal flow line are separately described, the former is referred to as “completion session” and the latter is referred to as “withdrawal session”. In addition, when the pattern extracted from the completion session and the pattern extracted from the withdrawal session are distinguished from each other and described, the former is referred to as a “completion pattern” and the latter is referred to as a “withdrawal pattern”. In this way, in order to separately extract the completion pattern and the withdrawal pattern, there is a pattern which appears only in the withdrawal session. By extracting such a pattern, the withdrawal cause or the like can be easily grasped. The extraction unit 21 delivers the extracted pattern for each user to the conversion unit 22.

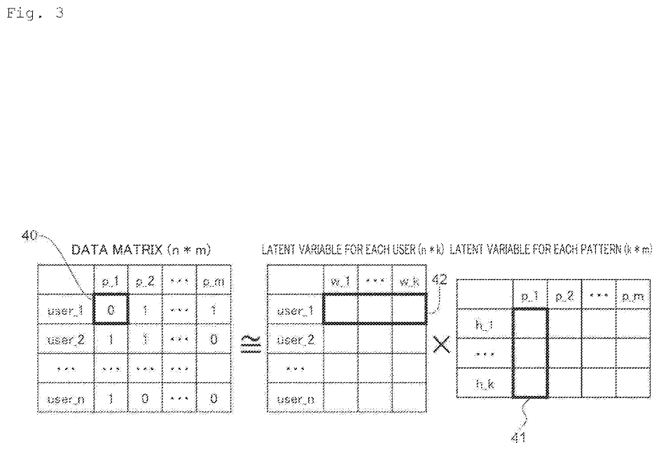

The data matrix creation unit 23 of the conversion unit 22 creates a data matrix in which the presence or absence of appearance for each pattern is stored from the pattern for each user delivered from the extraction unit 21, Specifically, the data matrix creation unit 23 creates a data matrix as shown in the left side of FIG. 3. In the data matrix of FIG. 3, each of “user_1”, “user_2”, . . . , “user_n” indicates user identification information, and n represents the number of users. In addition, each of “p_1”, “p_2”, . . . , “p_m” indicates pattern identification information, and m represents the number of the extracted patterns. In addition, in each cell 40 of the data matrix, “1” is stored when the pattern of the column corresponding to the cell is included in the session of the user of the row corresponding to the cell, and “0” is stored when the pattern is not included. The data matrix creation unit 23 delivers the created data matrix to the dimension compression unit 24.

Since the types of patterns to be extracted by the extraction unit 21 are very many, the dimension compression unit 24 of the conversion unit 22 performs dimension compression of the data matrix delivered from the data matrix creation unit 23 and converts the pattern of each user into latent variables of each user. For the dimension compression of the data matrix, for example, NMF (Non-negative Matrix Factorization) or the like may be used. Specifically, as shown in the right side of FIG. 3, the dimension compression unit 24 disassembles the data matrix into a latent variable for each user and a latent variable for each pattern. In the latent variable for each pattern, each column 41 represents a basis vector for each pattern, “h_1”, . . . , “h_k” are the latent variables constituting the basis vector, and k is the number of latent Variables. Also, in the latent variable for each user, each row 42 represents a latent variable vector for each user, “w_1”, . . . , “w_k” represent values (weights) of each latent variable “h_1”, . . . , “h_k”.

Thus, the pattern for each user is converted into a low-dimension latent variable having the latent variable vector for each user as a feature amount. The dimension compression unit 24 delivers the converted latent variable for each user to the creation unit 25.

The creation unit 25 creates a decision tree to be a classification model for classifying the completion pattern and the withdrawal pattern on the basis of the latent variable for each user delivered from the dimension compression unit 24. For example, the creation unit 25 learns the decision tree with the latent variable converted from the completion pattern as positive example (“1”) training data and the latent variable converted from the withdrawal pattern as negative example (“0”) training data. For learning the decision tree, for example, a LightGBM (Light Gradient Boosting Machine) or the like may be used. The creation unit 25 delivers the created decision tree to the calculation unit 26 and the visualization unit 29.

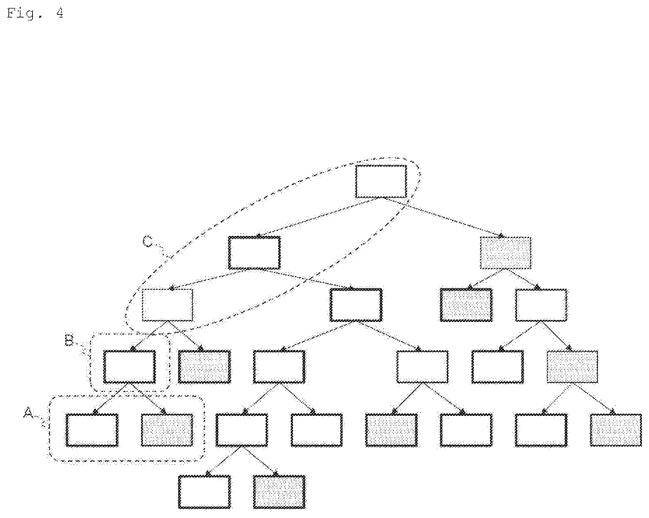

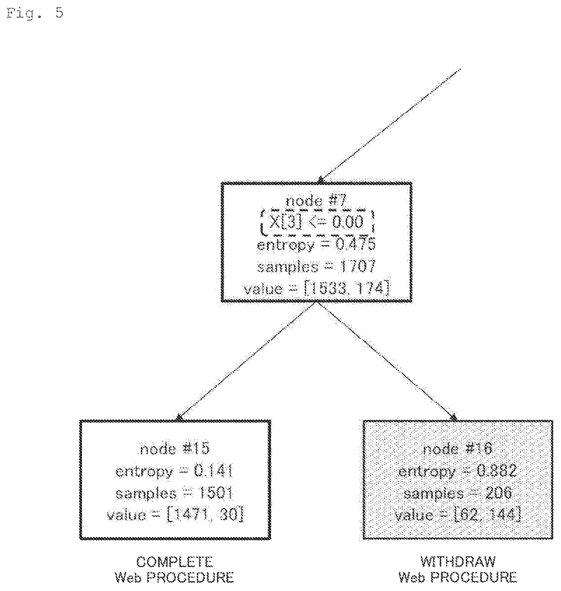

FIG. 4 shows a schematic diagram of one example of the decision tree. In addition, FIG. 5 is an enlarged diagram of a part of the decision tree (portions A and B in FIG. 4). In FIG. 4 and FIG. 5, each box represents a node, a white node corresponds to a class of the positive example, and a meshed node corresponds to a class of the negative example. In addition, the thickness of the line of each node represents impurity, and the lower the impurity, the thicker the line is. The parameters of each node will be described with reference to the upper node of FIG. 5. The first line in the node is identification information of the node, the second line is a branch condition corresponding to the latent variable, the third line is entropy showing the impurity, the fourth line is the amount of learning data classified into the node, and the fifth line is the amount of data for each class of the learning data classified into the node. Since the lower node in FIG. 5 is a leaf node having no further branch, the branch condition of the second line described above is not provided.

The calculation unit 26 calculates a contribution degree to prediction by the classification model for each latent variable by using the decision tree delivered from the creation unit 25 as the classification model.

Specifically, the rank decision unit 27 of the calculation unit 26 predicts the test data by using the classification model and obtains a prediction score (prediction probability) of each test data. The rank decision unit 27 ranks the prediction scores of each of the test data in the descending order and calculates an evaluation value of the classification model for each rank of the prediction scores. The evaluation value may be ROC-AUC (Receiver Operating Characteristic-Area Under the Curve), Average Precision, and the like. Then, the rank decision unit 27 decides a rank to be adopted on the basis of the relation between the rank and the evaluation value. For example, the rank decision unit 27 decides a rank as the rank to be adopted, in which a value of the evaluation value does not change in a graph in which the evaluation value is taken as a vertical axis and the rank is taken as a horizontal axis. The rank decision unit 27 notifies the prediction contribution calculation unit 28 of the decided rank.

The prediction contribution calculation unit 28 of the calculation unit 26 calculates a contribution degree of each latent variable when prediction is performed by the classification model for the test data corresponding to the rank notified from the rank decision unit 27. For the calculation of the contribution degree, for example, SHAP (SHapley Additive explanations) may be used. The calculation unit 26 delivers the calculated contribution degree of each latent variable to the visualization unit 29.

The visualization unit 29 visualizes information related to the classification of the completion pattern and the withdrawal pattern on the basis of the classification model by using the decision tree delivered from the creation unit 25 as the classification model.

In this case, based on the value of the latent variable for each user and the branch condition of each node by the classification model (decision tree) created by the creation unit 25, the transition traced from the root node to the leaf node corresponds to one pattern. In addition, the pattern corresponding to the transition reaching the leaf node representing the class of the positive example is the completion pattern, and the pattern corresponding to the transition reaching the leaf node representing the class of the negative example is the withdrawal pattern. Therefore, attention should be paid to a portion for dividing the leaf node representing the class of the positive example and the leaf node representing the class of the negative example and a point having a difference in comparison of the action dividing them may have a high possibility of causing the withdrawal in the case of trying to perform the Web procedure. That is, for example, for the pattern reaching the leaf node indicated by the broken line part A in FIG. 4, in order to grasp the action for dividing a case where the Web procedure is completed and a case where the Web procedure is withdrawn, the node (broken line part B in FIG. 4) connected to the leaf node is noted. This is because a common action is represented from the route node to the node immediately before the node to be noted (broken line part C in FIG. 4) and the action corresponding to the node to be noted divides whether the Web procedure is completed or withdrawn.

For example, as shown in FIG. 5, the branch condition of the node to be noted (broken line part in FIG. 5) is assumed to satisfy “X[3]≤0.00”. Note that X[3] represents the value w_3 of the latent variable. In this case, when the value w_3 of the latent variable of the user satisfies w_3≤0.00, it is the completion pattern, and w_3>0.00 is satisfied, it is the withdrawal pattern.

Then, the judgement unit 30 of the visualization unit 29 specifies the node connected to the leaf node for classifying the completion pattern and the withdrawal pattern in the classification model. Hereinafter, the specified node is referred to as a “specific node”. Note that, a plurality of candidates is provided for the pattern in which the user can complete the Web procedure and the pattern in which the user withdraws the Web procedure. For example, there may be a plurality of patterns capable of interpreting respective different causes of withdrawal, such as a pattern that has been lost and returned to the table of contents page and a pattern that has been given up halfway since the flow line to the procedure is too long. That is, since the classification model also includes transitions corresponding to the plurality of patterns, a plurality of specific nodes may be specified. Hereinafter, the processing related to the specific node is processing executed for each of the plurality of specified specific nodes.

The judgement unit 30 judges whether each leaf node connected to the specific node is the leaf node representing “Web procedure completion” or the leaf node representing “Web procedure withdrawal” on the basis of the branch condition corresponding to the value of the latent variable defined by the specific node. In the present embodiment, since the decision tree is created by defining the latent variable obtained by converting the completion pattern as the positive example, the leaf node to be branched when the branch condition of the specific node is satisfied is the leaf node representing “Web procedure completion”. The judgement unit 30 delivers the judgement result to the display unit 31.

The display unit 31 interprets the latent variable on the basis of a relationship between the latent variable defined as the branch condition by the specific node specified by the judgement unit 30 and the pattern before conversion.

Specifically, the display unit 31 converts the latent variable into the pattern by using the latent variable (the second term on the right side in FIG. 3) for each pattern converted by the dimension compression unit 24.

The display unit 31 generates a flow line aggregation screen including the classification model, the judgement result by the judgement unit 30, the pattern obtained by converting the latent variable, and the contribution degree calculated by the prediction contribution calculation unit 28 for each latent variable, Then, the display unit 31 displays the generated flow line aggregation screen on the display unit 16.

For example, the display unit 31 displays the classification model as shown in FIG. 4, and displays the determination result by the judgement unit 30 in association with each leaf node of the classification model. In an example shown in FIG. 5, an example is shown, in which the judgement result is written together in a lower part of the leaf node by characters. The display method of the judgement result is not limited to this, and the display modes of the leaf nodes such as the color and the line type may be made different in accordance with the judgement result.

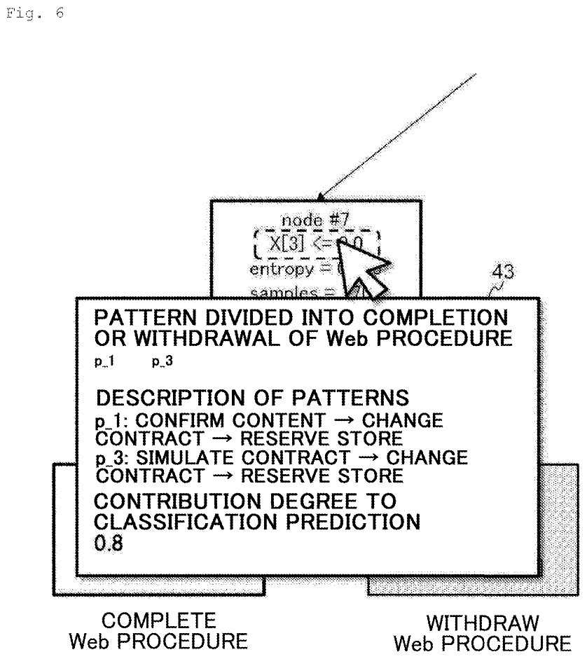

In addition, the display unit 31, for example, as shown in FIG. 6, when the specific node is selected, a pop-up display 43 including the pattern obtained by converting the latent variable corresponding to the specific node may be displayed. In an example shown in FIG. 6, the pop-up display 43 also includes a description of a pattern in which the pattern is expressed in a natural language. Further, the pop-up display 43 includes the contribution degree calculated for the latent variable before the conversion of the corresponding pattern. Note that, these pieces of information are not limited to being displayed in the pop-up display 43, but may also be displayed together with the specific node in the classification model. Note that, the display of the pattern obtained by converting the latent variable and the contribution degree may be omitted, and for not only the latent variable of the specific node but also a prescribed number of latent variables having the high contribution degree of all the latent variables, the contribution degree may be displayed.

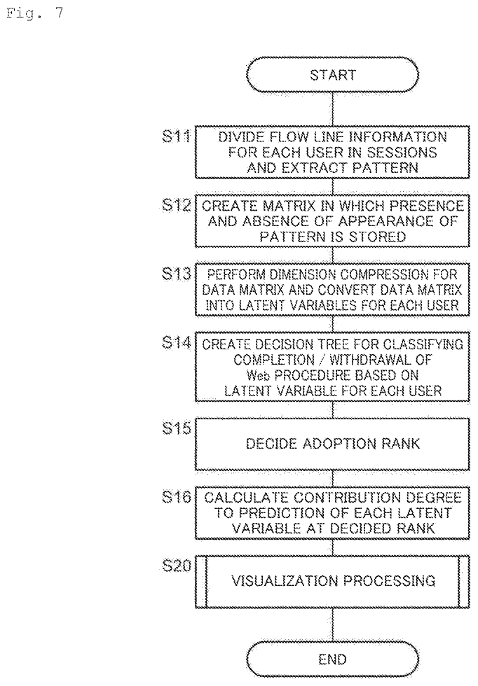

Next, operations of the flow line aggregation device 10 will be described. FIG. 7 is a flowchart showing a flow of flow line aggregation processing performed by the flow line aggregation device 10. The flow line aggregation processing is performed by allowing the CPU 11 to read the flow line aggregation program from the ROM 12 or the storage 14, deploy it into the RAM 13, and execute it. Note that the flow line aggregation processing is one example of the flow line aggregation method of the present disclosure.

In step S11, the CPU 11 acquires a plurality of pieces of flow line information stored in the flow line DB 20, divides the plurality of pieces of acquired flow line information into sessions, extracts the common page transition pattern from the session as the extraction unit 21.

Next, in step S12, the CPU 11 creates the data matrix in which the presence or absence of appearance for each pattern is stored from the pattern for each user as the data matrix creation unit 23. Next, in step S13, the CPU 11 performs dimension compression of the data matrix as the dimension compression unit 24 and converts the pattern for each user into the latent variable for each user.

Next, in step S14, the CPU 11 creates the decision tree to be the classification model for classifying the completion and withdrawal of the Web procedure, that is, the completion pattern and the withdrawal pattern on the basis of the latent variable for each user as the creation unit 25.

Next, in step S15, the CPU 11 decides the rank to be adopted on the basis of the relationship between the rank of the prediction score to the classification model and the evaluation value of the classification model for each rank as the rank decision unit 27. Next, in step S16, the CPU 11 calculates the contribution degree to prediction of each latent variable in the decided rank as the prediction contribution calculation unit 28.

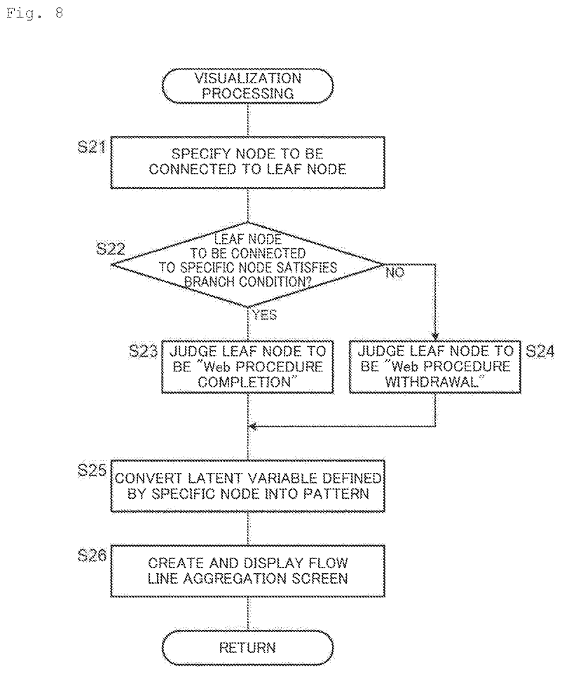

Next, in step 820, the visualization processing is executed. Here, the visualization processing will be described with reference to FIG. 8.

In step S21, the CPU 11 specifies the node connected to the leaf node for classifying the completion pattern and the withdrawal pattern as the specific node in the classification model as the judgement unit 30.

Next, in step S22, the CPU 11 determines whether or not each of the two leaf nodes connected to the specified node is the leaf node to be the branch destination when the branch condition of the specific node is satisfied as the judgement unit 30. In the case of positive judgement, the processing is shifted to step S23, and the CPU 11 judges that the leaf node is a leaf node representing “Web procedure completion” as the judgement unit 30. On the other hand, in the case of negative judgement, the processing is shifted to step S24, and the CPU 11 judges that the leaf node is a leaf node representing “web procedure withdrawal” as the judgement unit 30.

Next, in step S25, the CPU 11 uses the latent variable for each pattern converted by the dimension compression unit 24 and converts the latent variable defined by the specific node as the display unit 31. Next, in step S26, the CPU 11 generates the flow line aggregation screen including the classification model, the judgement result of above-described step S23 or step S24, the pattern obtained by converting the latent variable, and the contribution degree to prediction for each latent variable as the display unit 31. Then, the CPU 11 displays the generated flow line aggregation screen on the display unit 16 as the display unit 31, terminates the visualization processing, returns to the flow line aggregation processing (FIG. 7), and the flow line aggregation processing is terminated.

As described above, the flow line aggregation device according to the first embodiment extracts the common page transition pattern for each of the completion flow line in which the Web procedure has been completed and the withdrawal flow line in which the Web procedure has been withdrawn from the plurality of pieces of flow line information indicating the Web page transition for each user. In addition, the flow line aggregation device creates the matrix in which the presence of absence of appearance for each pattern is stored from the extracted pattern for each user, perform the dimension compression for the matrix, and converts the matrix into the latent variable for each user. Then, the flow line aggregation device creates the decision tree for classifying the pattern in which the Web procedure has been completed and the pattern in which the Web procedure has been withdrawn on the basis of the latent variable for each user. Further, the flow line aggregation device visualizes the information related to the classification of the pattern in which the Web procedure has been completed and the pattern in which the Web procedure has been withdrawn on the basis of the decision tree.

Thus, the Web flow lines can be aggregated so that the person can easily interpret. Specifically, since the flow lines are aggregated in the Web flow line of the user with high arbitrariness and the pattern likely to be related to the withdrawal is guessed, the analysis is facilitated as compared to comparing thousands and ten thousands pieces of flow line information by visual inspection to investigate the withdrawal cause. In addition, the pattern (conversion pattern) for completing the Web procedure is easily compared with the pattern for withdrawing.

Further, the flow line aggregation device according to the first embodiment, in the decision tree as the classification model, on the basis of the branch condition corresponding to the latent variable of the specific node, judges whether or not the leaf node to be connected is a leaf node representing “Web procedure completion” or a leaf node representing “Web procedure withdrawal” to visualize it. By paying attention to the node for dividing the completion or the withdrawal of the Web procedure among the nodes of decision tree, the analysis by the visual inspection becomes easier.

In addition, the flow line aggregation device according to the first embodiment visualizes information obtained by converting the latent variable defined as the branch condition in the specific node into the pattern before the dimension compression as interpretation of the latent variable. This makes it easier to grasp the withdrawal cause.

In addition, the flow line aggregation device according to the first embodiment calculates the contribution degree of the latent variable to prediction of the classification model to visualize it. Thus, even when there is the plurality of patterns for dividing the completion and the withdrawal of the Web procedure in the aggregation result, the visualization supports the determination of which pattern has higher priority.

### Second Embodiment

Next, a second embodiment will be described. In the first embodiment, when the decision tree becomes large and complicated, readability becomes low. In the second embodiment, a description will be given of a method for improving the readability by deciding a portion to be used as a classification model in a decision tree so as to minimize a size of a classification model while suppressing changes in evaluation values of the classification model.

Since a hardware configuration of the flow line aggregation device 210 according to the second embodiment is the same as the hardware configuration of the flow line aggregation device 10 according to the first embodiment shown in FIG. 1, description thereof will be omitted.

Next, a functional configuration of the flow line aggregation device 210 according to the second embodiment will be described. Note that, in the flow line aggregation device 210 according to the second embodiment, the same constituent components as those of the flow line aggregation device 10 according to the first embodiment are denoted by the same reference signs and detailed description thereof will be omitted.

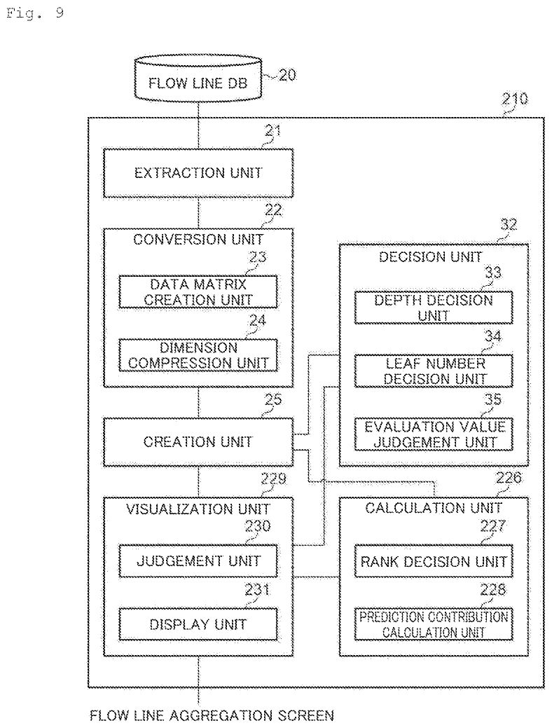

FIG. 9 is a block diagram showing an example of the functional configuration of the flow line aggregation device 210. As shown in FIG. 9, the flow line aggregation device 210 has an extraction unit 21, a conversion unit 22, a creation unit 25, a decision unit 32, a calculation unit 226, and a visualization unit 229 as the functional configuration. The decision unit 32 further includes a depth decision unit 33, a leaf number decision unit 34, and an evaluation value judgement unit 35. The calculation unit 226 further includes a rank decision unit 227 and a prediction contribution calculation unit 228. The visualization unit 229 further includes a judgement unit 230 and a display unit 231. Each functional constituent component is realized by causing the CPU 11 to read the flow line aggregation program stored in the ROM 12 or the storage 14, deploy it into the RAM 13, and execute it.

The decision unit 32 decides the minimum size in which the evaluation value when the size of the decision tree is reduced does not decrease by a prescribed value or more from a standard by using the evaluation value (for example, AUC) of the decision tree created by the creation unit 25 as the standard. When the evaluation value does not significantly decrease, the smaller the depth and the number of leaf nodes, the simpler the classification model and the easier to interpret the aggregation results of flow line information.

Specifically, the depth decision unit 33 of the decision unit 32 determines the depth of the decision tree that does not significantly decrease the evaluation value as the classification model of the decision tree. Specifically, the depth decision unit 33 makes the evaluation value judgement unit 35 described later judge a change of the evaluation value as the classification model of the decision tree when the depth max depth of the decision tree is changed to two stages, three stages, with respect to a standard evaluation value.

The depth decision unit 33 decides the minimum max depth as the depth of the decision tree among depths max depth in which the reduction of the evaluation value judged by the evaluation value judgement unit 35 becomes equal to or less than the prescribed value.

The leaf number decision unit 34 of the decision unit 32 decides a number which is small in the reduction amount of the evaluation value and is as close as zero as possible as the number of leaf nodes when the number of leaf nodes is increased one by one for the decision tree of the depth decided by the depth decision unit 33. Specifically, the leaf number decision unit 34 makes the evaluation value judgement unit 35 described later judge a decrease amount of the evaluation value as the classification model of the decision tree when the number of leaf nodes max leaf nodes is increased one by one for the decision tree of the decided depth with respect to the standard evaluation value. The leaf number decision unit 34 decides the minimum max leaf nodes among the number of leaf nodes max leaf nodes in which the reduction amount of the evaluation value judged by the evaluation value judgement unit 35 is equal to or less than the prescribed value as the number of leaf nodes in the decision tree.

The evaluation value judgement unit 35 of the decision unit 32 judges the change of the evaluation value as the classification model of the decision tree in the depth to be changed by the depth decision unit 33 and the number of leaf nodes to be changed by the leaf number decision unit 34 with respect to the standard evaluation value.

Thus, by deciding the max depth and the max leaf nodes in which the evaluation value does not significantly change with respect to the standard evaluation value, the classification model having the small size can be realized.

In the calculation unit 226 and the visualization unit 229, the classification model to be processed is not the decision tree created by the creation unit 25, but a classification model composed of a part of the decision tree specified by the depth and the number of leaf nodes decided by the decision unit 32. The others are the same as the calculation unit 26 and the visualization unit 29 of the first embodiment.

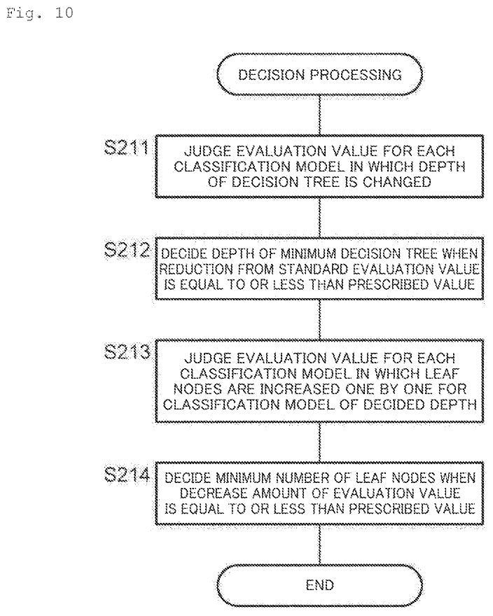

Next, operations of the flow line aggregation device 210 will be described. In the second embodiment, the flow line aggregation processing shown in FIG. 7 is executed in the same manner as that in the first embodiment. However, in the flow line aggregation device 210 according to the second embodiment, decision processing is executed after step S14. Here, the decision processing will be described with reference to FIG. 10.

In step S211, the CPU 11 makes the evaluation value judgement unit 35 judge the change of the evaluation value as the classification model of the decision tree when the depth of the decision tree is changed to two stages, three stages, . . . with respect to the standard evaluation value as the depth decision unit 33. Next, in step S212, the CPU 11 decides the minimum depth among the depths in which the decrease of the judged evaluation value is equal to or less than the prescribed value as the depth of the decision tree as the depth decision unit 33.

Next, in step S213, the CPU 11 makes the evaluation value judgement unit 35 judge the reduction amount of the evaluation value of the classification model composed of a part of the decision tree when the number of leaf nodes is increased one by one for the decision tree of the decided depth with respect to the standard evaluation value as the leaf number decision unit 34. Next, in step S214, the CPU 11 decides the minimum number as the number of leaf nodes of the decision tree among the numbers of leaf nodes in which the reduction amount of the judged evaluation value is equal to or less than the prescribed value as the leaf number decision unit 34, and the decision processing is terminated.

As described above, the flow line aggregation device according to the second embodiment decides the minimum depth of the decision tree and the minimum number of leaf nodes, in which the evaluation value when the size of the decision tree is reduced does not decrease by the prescribed value or more from the standard by using the evaluation value of the decision tree created by the creation unit as the standard. Thus, when the decision tree becomes too large, the reduction of the evaluation value is suppressed to the minimum and the depth and the number of leaf nodes of the decision tree are minimized, so that the classification model becomes smaller, the readability is improved, and the interpretation by visual inspection is facilitated.

Note that, in each of the above-described embodiments, as one example of the transition of the action or the state of each user, the flow line information indicating the transition of the Web page of each user has been described as a target, but the present invention is not limited to this. For example, flow line information indicating a movement locus of a user in a facility may be used as the target. In this case, for example, a flow line indicating the movement locus along a previously assumed route may be handled as a completion flow line, and a flow line indicating a movement locus deviating from the previously assumed route may be handled as a withdrawal flow line.

Note that various types of processors other than the CPU may execute the flow line aggregation processing that the CPU executes by reading software (programs) in the above-described embodiments. In this case, examples of the processor include a. PLD (Programmable Logic Device) whose circuit configuration can be changed after manufacturing, such as an FPGA (Field-Programmable Gate Array), a dedicated electric circuit that is a processor having a circuit configuration designed as a dedicated configuration to execute specific processing, such as an ASIC (Application Specific Integrated Circuit), and the like. In addition, the flow line aggregation processing may also be executed by one of these various processors, or may be executed by a combination of two or more processors of the same type or different types (for example, a plurality of FPGAS, a combination of the CPU and the FPGA, and so forth).

Further, more specifically, a hardware structure of these various processors is an electric circuit in which circuit elements such as semiconductor element are combined.

Furthermore, in the above-described embodiments, although an aspect has been described, in which the flow line aggregation program is previously stored (installed) in the ROM 12 or the storage 14, the present invention is not limited to this. The program may be provided in a form in which the program is stored in a non-transitory storage medium such as a CD-ROM (Compact Disk Read Only Memory), a DVD-ROM (Digital Versatile Disk Read Only Memory), or a USB (Universal Serial Bus) memory. In addition, the program may use the form in which the program is downloaded from an external device via a network.

The following supplements are disclosed regarding the above embodiments.

### Supplement Item 1

A flow line aggregation device including a memory and at least one processor connected to the memory, wherein the processor is configured to extract a common page transition pattern for each of a completion flow line in which Web procedure has been completed and a withdrawal flow line in which the Web procedure has been withdrawn from a plurality of pieces of flow line information indicating the Web page transition for each user, create a matrix in which presence or absence of appearance for each pattern is stored from the extracted pattern for each user, perform dimension compression for the matrix, and convert the matrix into a latent variable for the respective users,
create a decision tree for classifying the completion flow line and the withdrawal flow line on the basis of the converted latent variable for the respective users, and visualize information related to the classification of the completion flow line and the withdrawal flow line on the basis of the created decision tree.

### Supplement Item 2

A non-transitory recording medium storing a program executable by a computer so as to execute flow line aggregation processing, wherein
the flow line aggregation processing includes extracting a common page transition pattern for each of a completion flow line in which Web procedure has been completed and a withdrawal flow line in which the Web procedure has been withdrawn from a plurality of pieces of flow line information indicating the Web page transition for each user,
creating a matrix in which presence or absence of appearance for each pattern is stored from the extracted pattern for each user, performing dimension compression for the matrix, and converting the matrix into latent variables for the respective users,
creating a decision tree for classifying the completion flow line and the withdrawal flow line on the basis of the converted latent variable for the respective users, and visualizing information related to the classification of the completion flow line and the withdrawal flow line on the basis of the created decision tree.

### REFERENCE SIGNS LIST

10, 210 Flow line aggregation device
11 CPU
12 ROM
13 RAM
1.4 Storage
15 Input unit
16 Display unit
17 Communication I/F
19 Bus
20 Flow line DB
21 Extraction unit
22 Conversion unit
23 Data matrix creation unit
24 Dimension compression unit
25 Creation unit
26, 226 Calculation unit
27, 227 Rank decision unit
28, 228 Prediction contribution calculation unit
29, 229 Visualization unit
30, 230 Judgement unit
31, 231 Display unit
32 Decision unit
33 Depth decision unit
34 Leaf number decision unit
35 Evaluation value judgement unit

1. A flow line aggregation device configured to:
extract a common transition pattern for each of a completion flow line reaching an action or a state indicating completion and a withdrawal flow line withdrawing without reaching the action or the state indicating the completion from a plurality of pieces of flow line information indicating transition of the action or the state for each user;
create a matrix in which presence or absence of appearance for each pattern is stored from the pattern for each user extracted, perform dimension compression for the matrix, and convert the matrix into latent variables for the respective users;
create a decision tree for classifying the completion flow line and the withdrawal flow line on the basis of the latent variable for the respective users converted; and
visualize information related to the classification of the completion flow line and the withdrawal flow line on the basis of the decision tree created.

2. The flow line aggregation device according to claim 1, wherein the flow line aggregation device is further configured to:
determine whether each of the leaf nodes to be connected is a leaf node corresponding to the completion flow line or a leaf node corresponding to the withdrawal flow line on the basis of a branch condition corresponding to a value of the latent variable defined by a node to be connected to the leaf node in the decision tree and visualizes a judgement result.

3. The flow line aggregation device according to claim 2, wherein the flow line aggregation device is further configured to:
visualize information obtained by converting the latent variable defined as the branch condition in the node to be connected to the leaf node into a pattern before the dimension compression.

4. The flow line aggregation device according to claim 2, further configured to:
perform prediction for test data by using the decision tree, calculate an evaluation value of the decision tree for each rank of a prediction score of each piece of test data, and calculate a contribution degree of each latent variable for the test data corresponding to a rank decided on the basis of a relationship between the rank and the evaluation value when the prediction is performed by the decision tree, wherein
the contribution degree is visualized for each latent variable.

5. The flow line aggregation device according to claim 1, wherein the flow line aggregation device is further configured to:
decide the minimum depth of the decision tree and the minimum number of leaf nodes, in which the evaluation value when the size of the decision tree is reduced does not decrease by the prescribed value or more from a standard by using the evaluation value of the decision tree created as the standard.

6. The flow line aggregation device according to claim 1, wherein the flow line aggregation device is further configured to:
perform a non-negative matrix factorization on the matrix to convert the pattern of each user into the latent variable of each user.

7. A flow line aggregation method comprising:
extracting, a common transition pattern for each of a completion flow line reaching an action or a state indicating completion and a withdrawal flow line withdrawing without reaching the action or the state indicating the completion from a plurality of pieces of flow line information indicating transition of the action or the state for each user;
creating, a matrix in which presence or absence of appearance for each pattern is stored from the pattern for each user extracted, performing dimension compression for the matrix, and converting the matrix into latent variables for the respective users;
creating, a decision tree for classifying the completion flow line and the withdrawal flow line on the basis of the latent variable for the respective users converted; and
visualizing information related to the classification of the completion flow line and the withdrawal flow line on the basis of the decision tree created.

8. (canceled)

9. The flow line aggregation method according to claim 7, wherein the method further comprises:
determining whether each of the leaf nodes to be connected is a leaf node corresponding to the completion flow line or a leaf node corresponding to the withdrawal flow line on the basis of a branch condition corresponding to a value of the latent variable defined by a node to be connected to the leaf node in the decision tree and visualizes a judgement result.

10. The flow line aggregation method according to claim 9, wherein the method further comprises:
visualizing information obtained by converting the latent variable defined as the branch condition in the node to be connected to the leaf node into a pattern before the dimension compression.

11. The flow line aggregation method according to claim 9 wherein the method further comprises:
performing prediction for test data by using the decision tree, calculate an evaluation value of the decision tree for each rank of a prediction score of each piece of test data, and calculate a contribution degree of each latent variable for the test data corresponding to a rank decided on the basis of a relationship between the rank and the evaluation value when the prediction is performed by the decision tree, wherein
the contribution degree is visualized for each latent variable.

12. The flow line aggregation method according to claim 7, wherein the method further comprises:
deciding the minimum depth of the decision tree and the minimum number of leaf nodes, in which the evaluation value when the size of the decision tree is reduced does not decrease by the prescribed value or more from a standard by using the evaluation value of the decision tree created as the standard.

13. The flow line aggregation method according to claim 7, wherein the method further comprises:
performing a non-negative matrix factorization on the matrix to convert the pattern of each user into the latent variable of each user.

14. A computer-readable non-transitory recording medium storing computer-executable program instructions that when executed by a processor to execute a flow line aggregation method comprising:
extracting a common transition pattern for each of a completion flow line reaching an action or a state indicating completion and a withdrawal flow line withdrawing without reaching the action or the state indicating the completion from a plurality of pieces of flow line information indicating transition of the action or the state for each user;
creating a matrix in which presence or absence of appearance for each pattern is stored from the pattern for each user extracted, performing dimension compression for the matrix, and converting the matrix into latent variables for the respective users;
creating a decision tree for classifying the completion flow line and the withdrawal flow line on the basis of the latent variable for the respective users converted; and
visualizing information related to the classification of the completion flow line and the withdrawal flow line on the basis of the decision tree created.

15. The computer-readable non-transitory recording medium according to claim 14 wherein the method further comprises:
determining whether each of the leaf nodes to be connected is a leaf node corresponding to the completion flow line or a leaf node corresponding to the withdrawal flow line on the basis of a branch condition corresponding to a value of the latent variable defined by a node to be connected to the leaf node in the decision tree and visualizes a judgement result.

16. The computer-readable non-transitory recording medium according to claim 15, wherein the method further comprises:
visualizing information obtained by converting the latent variable defined as the branch condition in the node to be connected to the leaf node into a pattern before the dimension compression.

17. The computer-readable non-transitory recording medium according to claim 15 wherein the method further comprises:
performing prediction for test data by using the decision tree, calculate an evaluation value of the decision tree for each rank of a prediction score of each piece of test data, and calculate a contribution degree of each latent variable for the test data corresponding to a rank decided on the basis of a relationship between the rank and the evaluation value when the prediction is performed by the decision tree, wherein
the contribution degree is visualized for each latent variable.

18. The computer-readable non-transitory recording medium according to claim 14, wherein the method further comprises:
deciding the minimum depth of the decision tree and the minimum number of leaf nodes, in which the evaluation value when the size of the decision tree is reduced does not decrease by the prescribed value or more from a standard by using the evaluation value of the decision tree created as the standard.

19. The computer-readable non-transitory recording medium according to claim 14, wherein the method further comprises:
performing a non-negative matrix factorization on the matrix to convert the pattern of each user into the latent variable of each user.
